(19) United States
(12) Patent Application Publication
(10) Pub. No.: US 2026/0316774 A1
(43) Pub. Date: Oct. 15, 2026

(54) APPARATUS AND METHOD FOR PREVENTING ERRONEOUS OPERATION OF ACCELERATOR INPUT, AND A VEHICLE AND A STORAGE MEDIUM INCLUDING THE SAME

(71) Applicants: HYUNDAI MOTOR COMPANY, Seoul (KR); KIA CORPORATION, Seoul (KR)

(72) Inventor: Kyu Won Kim, Hwaseong-si (KR)

(73) Assignees: HYUNDAI MOTOR COMPANY, Seoul (KR); KIA CORPORATION, Seoul (KR)

(21) Appl. No.: 19/305,098

(22) Filed: Aug. 20, 2025

(30) Foreign Application Priority Data
Apr. 9, 2025 (KR) 10-2025-0046030

(51) Int. Cl. B60W 50/12

(52) U.S. Cl. CPC B60W 50/12; B60W 2520/105; B60W 2556/10; B60W 2720/106

(57) ABSTRACT

An apparatus for preventing an erroneous operation of an accelerator input includes a controller. The controller is configured to receive per-time acceleration data of a vehicle from a sensor unit. The controller is further configured to determine a normal acceleration range by accumulating the per-time acceleration data. The controller is further configured to selectively output an acceleration alarm signal or an acceleration limit signal based on whether at least a portion of the per-time acceleration data is beyond the normal acceleration range.

### CROSS-REFERENCE TO RELATED APPLICATION(S)

This application claims the benefit of and priority to Korean Patent Application No. 10-2025-0046030 filed on Apr. 9, 2025 in the Korean Intellectual Property Office, the entire contents of which are incorporated herein by reference.

### TECHNICAL FIELD

The present disclosure relates to an apparatus and a method for preventing an erroneous operation of an accelerator input, a vehicle, and a storage medium.

### BACKGROUND

Recently, as an increase in the number of traffic accidents caused by elderly drivers due to the phenomenon of an aging population has become a social problem, major countries have established policies to strengthen physical and aptitude tests for elderly drivers or to place restrictions on drivers' licenses.

In general, as elderly people age, their physical structure and visual and auditory cognitive abilities may deteriorate, resulting in poor judgment, decreased concentration, and slow reaction speeds, which increases the risk of accidents while driving. In particular, elderly drivers may develop neurological diseases, such as dementia, Parkinson's disease, or experience strokes, without their knowledge, and the fatality rate may be high when accidents occur due to these diseases and conditions. For example, many traffic accidents caused by elderly drivers are due to erroneous operation cases, such as pressing an accelerator pedal when a brake pedal has to be pressed, and many cases occur when a driver momentarily loses their sense of direction and drives on the sidewalk instead of the roadway or drives in the opposite direction to the direction of traffic.

In addition, because automatic transmission vehicles do not have a clutch pedal, the brake pedal is installed on one side of the accelerator pedal, and inexperienced drivers, elderly drivers, or even experienced drivers may operate the accelerator and brake pedals simultaneously or mistakenly use the accelerator pedal as the brake pedal when braking suddenly in an emergency situation. This may result in the vehicle rapidly accelerating instead of braking suddenly, which increases the material and human damage caused by the accident. The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

An aspect of the present disclosure aims to provide an apparatus and a method for preventing an erroneous operation of an accelerator input, and a vehicle, and a storage medium, capable of improving the accuracy/reliability of preventing an erroneous operation of an accelerator input for drivers with various driving tendencies.

According to an aspect of the present disclosure, an apparatus for preventing an erroneous operation of an accelerator input includes a controller configured to receive per-time acceleration data of a vehicle from a sensor unit. The controller is further configured to determine a normal acceleration range by accumulating the per-time acceleration data. The controller is further configured to selectively output an acceleration alarm signal or an acceleration limit signal based on whether at least a portion of the per-time acceleration data is beyond the normal acceleration range.

The accumulated per-time acceleration data may include per-time acceleration data of a recent time range and per-time acceleration data of a time range older than the recent time range. The controller may further determine the normal acceleration range based on the per-time acceleration data of the recent time range.

The recent time range may include a plurality of driving time ranges of the vehicle. The plurality of driving time ranges may be distinguished from each other by an ON/OFF status of the vehicle. The controller may further determine the normal acceleration range based on per-time acceleration data of the plurality of driving time ranges.

The controller may further determine the normal acceleration range based on a comprehensive average and a comprehensive standard deviation of the plurality of driving time ranges.

The controller may further determine the normal acceleration range based on an average and a standard deviation of at least a portion of the accumulated per-time acceleration data.

The controller may further receive accelerator input data from the sensor unit and selectively output the acceleration alarm signal or acceleration limit signal based on whether an accelerator input value may be greater than or equal to an accelerator input reference.

The normal acceleration range may be variable based on the accumulated per-time acceleration data, and the accelerator input reference may be fixed.

The controller may further output the acceleration alarm signal based on an output condition being satisfied. The controller may further output the acceleration limit signal based on satisfaction of the output condition continuing until a reference time has elapsed since the acceleration alarm signal was output. The output condition may include at least one of a first condition in which at least a portion of the per-time acceleration data may be beyond the normal acceleration range or a second condition in which the accelerator input value may be greater than or equal to the accelerator input reference.

According to another aspect of the present disclosure, a method for preventing an erroneous operation of an accelerator input includes receiving per-time acceleration data from a sensor unit. The method further includes determining a normal acceleration range by accumulating the per-time acceleration data. The method further includes selectively outputting an acceleration alarm signal or an acceleration limit signal based on whether at least a portion of the per-time acceleration data may be beyond the normal acceleration range.

The accumulated per-time acceleration data may include per-time acceleration data of a recent time range and per-time acceleration data of a time range older than the recent time range. Determining the normal acceleration range may include determining the normal acceleration range based on the per-time acceleration data of the recent time range.

Determining the normal acceleration range may include determining the normal acceleration range based on an average and standard deviation of the recent time range.

Receiving the per-time acceleration data may include receiving accelerator input data from the sensor unit. Selectively outputting the acceleration alarm signal or the acceleration limit signal may include selectively outputting the acceleration alarm signal or acceleration limit signal based on whether an accelerator input value may be greater than or equal to an accelerator input reference.

Selectively outputting the acceleration alarm signal or the acceleration limit signal may include outputting the acceleration alarm signal when an output condition may be satisfied; and outputting the acceleration limit signal when satisfaction of the output condition continues until a reference time has elapsed since the acceleration alarm signal was output. The output condition may include at least one of a first condition in which at least a portion of the per-time acceleration data may be beyond the normal acceleration range or a second condition in which the accelerator input value may be greater than or equal to the accelerator input reference.

According to another aspect of the present disclosure, there is provided a storage medium for recording at least one program including instructions for executing the method for preventing the erroneous operation of the accelerator input.

According to another aspect of the present disclosure, a vehicle includes a controller including a processor and a storage medium for recording at least one program configured to be executable by the processor. The at least one program includes instructions for executing the method for preventing the erroneous operation of the accelerator input.

According to another aspect of the present disclosure, a vehicle includes a sensor unit configured to receive per-time acceleration data of a vehicle; and a controller. The controller is configured to determine a normal acceleration range by accumulating the per-time acceleration data. The controller is further configured to selectively output an acceleration alarm signal or an acceleration limit signal based on whether at least a portion of the per-time acceleration data may be beyond the normal acceleration range.

### BRIEF DESCRIPTION OF DRAWINGS

The and other aspects, features, and advantages of the present disclosure should be more clearly understood from the following detailed description, taken in conjunction with the accompanying drawings, in which:

FIG. 1 is a diagram illustrating an apparatus for preventing an erroneous operation of an accelerator input, a vehicle, and a storage medium according to an embodiment of the present disclosure;

FIG. 2 is a flowchart illustrating a method for preventing an erroneous operation of an accelerator input according to an embodiment of the present disclosure;

FIG. 3 is a graph illustrating an acceleration alarm signal or an acceleration limit signal selectively output according to whether at least a portion of per-time acceleration data is outside of a normal acceleration range in an apparatus and a method for preventing an erroneous operation of an accelerator input, a vehicle, and a storage medium according to an embodiment of the present disclosure;

FIG. 4 is a graph illustrating a normal acceleration range determined based on the accumulation of per-time acceleration data in an apparatus and a method for preventing an erroneous operation of an accelerator input, a vehicle, and a storage medium according to an embodiment of the present disclosure;

FIG. 5 is a flowchart illustrating outputting an acceleration alarm signal and an acceleration limit signal according to an accelerator input value and acceleration in an apparatus and a method for preventing an erroneous operation of an accelerator input, a vehicle, and a storage medium according to an embodiment of the present disclosure; and

FIG. 6 is a flowchart illustrating determining a normal acceleration range based on at least some (e.g., a recent time range, a plurality of driving time ranges) of accumulated per-time acceleration data in an apparatus and method for preventing an erroneous operation of an accelerator input, a vehicle, and a storage medium according to an embodiment of the present disclosure.

### DETAILED DESCRIPTION

While the present disclosure may be modified in various ways and take on various alternative forms, specific embodiments thereof are shown in the drawings and described in detail below. However, it should be understood that there is no intent to limit the present disclosure to the particular forms disclosed. On the contrary, the present disclosure covers all modifications, equivalents, and alternatives falling within the spirit and scope of the present disclosure.

It should be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

The terms used herein to describe embodiments of the present disclosure is not intended to limit the scope of the present disclosure. The articles “a,” and “an” are singular in that they have a single referent, but the use of the singular form in the present document should not preclude the presence of more than one referent. In other words, elements of the present disclosure in the singular may be also in the plural form, unless the context clearly indicates otherwise. It should be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

Unless defined in a different way, all the terms used herein including technical and scientific terms have the same meanings as understood by those having ordinary skill in the art to which the present disclosure pertains. Such terms as defined in generally used dictionaries should be construed to have the same meanings as those of the contexts of the related art, and unless clearly defined in the application, the terms should not be construed to have ideally or excessively formal meanings.

In the present disclosure, vehicles refer to a variety of vehicles that move transported objects, such as people, animals, or goods, from a starting point to a destination. These vehicles are not limited to vehicles that run on roads or tracks.

Hereinafter, embodiments of the present disclosure should be described with reference to the accompanying drawings.

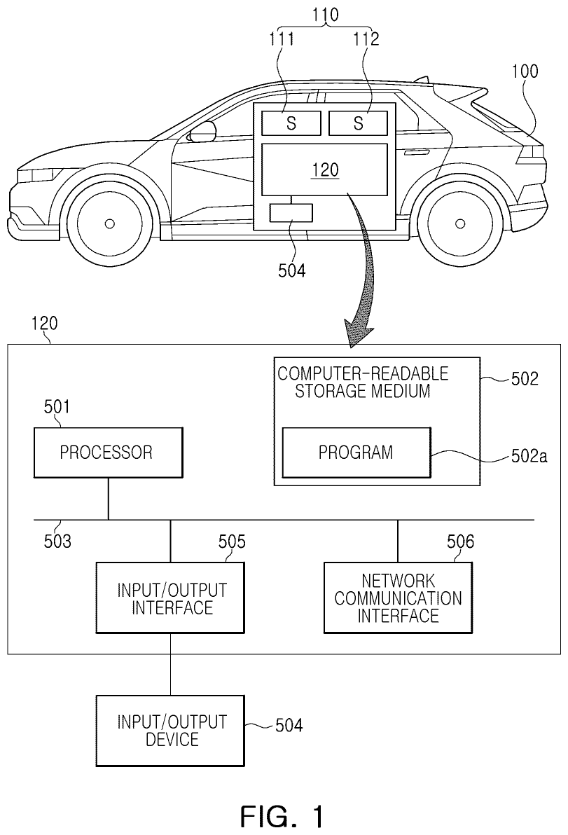

Referring to FIG. 1, an apparatus for preventing an erroneous operation of an accelerator input according to an embodiment of the present disclosure may include a controller 120 and a vehicle 100 according to an embodiment of the present disclosure may include a sensor unit 110 and a controller 120.

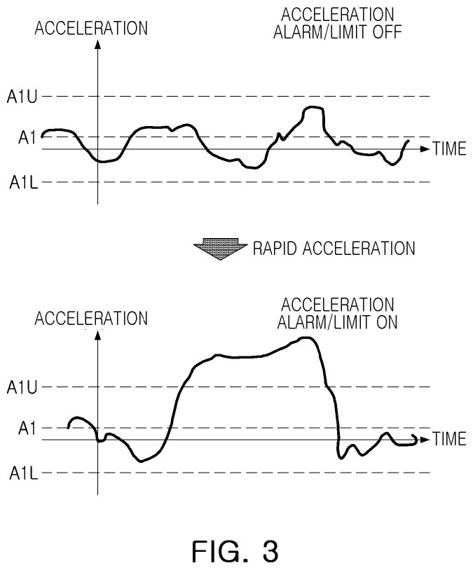

Referring to FIGS. 1 and 3, the controller 120 may receive per-time acceleration data of the vehicle 100 from the sensor unit 110, may determine a normal acceleration range (e.g., a range below A1U in FIG. 3) based on the accumulation of the per-time acceleration data, and may selectively output an acceleration alarm signal or an acceleration limit signal based on whether at least a portion of the per-time acceleration data is beyond the normal acceleration range.

Referring to FIGS. 1, 2, and 3, a method for preventing an erroneous operation of acceleration input according to an embodiment of the present disclosure may include an operation (S110) of receiving per-time acceleration data of the vehicle 100 from the sensor unit 110; an operation (S120) of determining a normal acceleration range (e.g., a range below A1U in FIG. 3) based on the accumulation of the per-time acceleration data; and an operation (S130) of selectively outputting an acceleration alarm signal or an acceleration limit signal based on whether at least a portion of the per-time acceleration data is beyond the normal acceleration range. The controller 120 may execute the method for preventing an erroneous operation of an accelerator input.

For example, accumulated per-time acceleration data of a first vehicle of an economical driver who considers energy efficiency when driving may have an overall low acceleration value. Therefore, an upper limit of the normal acceleration range of the first vehicle may be low.

For example, the accumulated per-time acceleration data of a second vehicle of a sporty driver who prefers acceleration when driving may have an overall high acceleration value. Therefore, an upper limit of the normal acceleration range of the second vehicle may be high.

Accordingly, the apparatus and the method for preventing an erroneous operation of an accelerator input, the vehicle, and the storage medium according to an embodiment of the present disclosure may determine an adaptive normal acceleration range for the driver's driving tendencies. Thus, the apparatus, the method, the vehicle, and the storage medium may improve the accuracy of determining whether to output an acceleration alarm signal or an acceleration limit signal for drivers with various driving tendencies and may improve the accuracy/reliability of preventing an erroneous operation of an accelerator input for drivers with various driving tendencies.

In addition, the apparatus and method for preventing an erroneous operation of an accelerator input, the vehicle, and the storage medium according to an embodiment of the present disclosure may not be based on external vehicle data (e.g., camera data, radar data, lidar data) that may be temporarily abnormal due to environmental factors. Thus, a time gap for causing an erroneous operation of an accelerator input may be prevented, and the stability of preventing an erroneous operation of an accelerator input may be secured.

The sensor unit 110 may include an acceleration sensor 111 and/or an accelerator input sensor 112. For example, the acceleration sensor 111 may monitor (continuously sense) a longitudinal acceleration of the vehicle 100, thereby periodically generating per-time acceleration data (e.g., generating at a predetermined time interval) and transmitting the per-time acceleration data to the controller 120. The longitudinal direction may be set as a straight direction of the vehicle 100. Hereinafter, the acceleration of the per-time acceleration data may correspond to the longitudinal acceleration.

In the receiving operation (S110), the controller 120 may receive accelerator input data from the accelerator input sensor 112 of the sensor unit 110. For example, the accelerator input sensor 112 may monitor (continuously sense) accelerator input of the driver of the vehicle 100, thereby periodically generating the accelerator input data and transmitting the accelerator input data to the controller 120. For example, the accelerator input sensor 112 may be implemented as an accelerator pedal sensor (APS).

If at least a portion of the per-time acceleration data is lower than the upper limit A1U of the normal acceleration range, the controller 120 may not output the acceleration alarm signal or the acceleration limit signal by turning off an acceleration alarm/limit. If at least a portion of the per-time acceleration data is higher than the upper limit A1U of the normal acceleration range, the controller 120 may output the acceleration alarm signal or the acceleration limit signal by turning on the acceleration alarm/limit.

For example, a time criterion for determining whether at least a portion of the per-time acceleration data is outside of the normal acceleration range (e.g., the range below A1U) may be longer than the time interval of the per-time acceleration data. For example, if the time interval is N (e.g., 1) seconds and the time criterion is N*M (e.g., 1*10) seconds, the controller 120 may determine whether M (e.g., 10) or more of the per-time acceleration data continuously deviate from the normal acceleration range and may selectively output an acceleration alarm signal or an acceleration limit signal according to a determination result.

For example, an input/output device 504 of the controller 120 may output an acceleration alarm signal that the driver may recognize (e.g., visually recognize, auditorily recognize). By recognizing that the acceleration alarm signal is output, the driver may determine that the current accelerator input is being erroneously operated and may stop the accelerator input.

For example, a network communication interface 506 of the controller 120 may output an acceleration limit signal that may control the operation of a specific element of the vehicle 100. Accordingly, the vehicle 100 may stop acceleration.

For example, the specific element may include, but is not limited to, at least one of an accelerator input receiver (e.g., a pedal), a gear input receiver, a transmission, an engine, or a motor of the vehicle 100. For example, the controller 120 may include, but is not limited to, at least one of an electronic control unit (ECU), an engine control unit (ECU), a transmission control unit (TCU), or a motor controller or may control an ECU, a TCU, or a motor controller.

For example, the controller 120 may output the acceleration limit signal to temporarily disable the accelerator input receiver (e.g., the pedal). The controller 120 may further output the acceleration limit signal to reduce torque of the engine (and/or the motor). The controller 120 may further output an acceleration limit signal to cut off fuel supply to the engine (e.g., forcibly cut off a throttle of the engine) or output the acceleration limit signal to cut off the electrical connection between the motor and a high-voltage battery, but is not limited thereto.

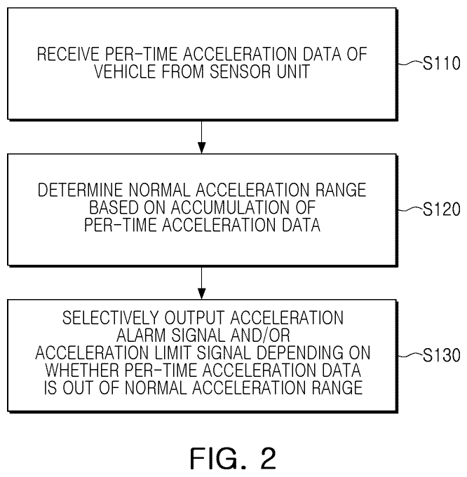

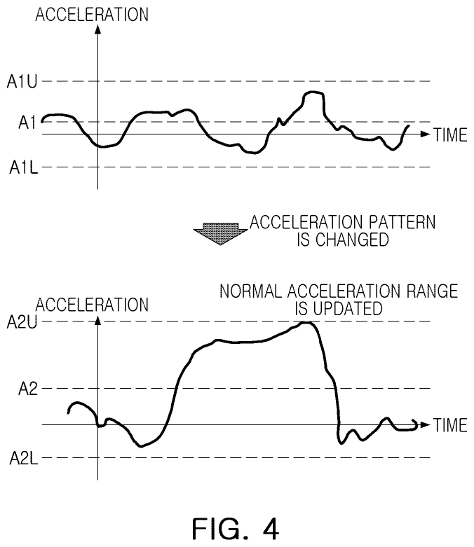

Referring to FIG. 4, in the determining operation (S120 of FIG. 2), the controller (120 of FIG. 1) may determine the normal acceleration range (range below A1U, range below A2U) based on the averages A1 and A2 and standard deviation of at least some of the accumulated per-time acceleration data. Accordingly, the accuracy/reliability of preventing an erroneous operation of an accelerator input for drivers with various driving tendencies may be further improved.

For example, the accumulated per-time acceleration data of the first vehicle of an economical driver who considers energy efficiency when driving may have an overall low acceleration value and an overall gentle acceleration change rate and thus may have a relatively low average A1 and a relatively small standard deviation. The controller may lower the upper limit A1U of the normal acceleration range by positioning the normal acceleration range to be low due to the relatively low average A1 of the accumulated per-time acceleration data. The controller may lower the upper limit A1U of the normal acceleration range by determining the normal acceleration range to be narrow due to the relatively small standard deviation of the accumulated per-time acceleration data.

For example, the accumulated per-time acceleration data of the second vehicle of a sporty driver who prefers acceleration when driving may have a relatively high acceleration value overall and a rapid acceleration change rate overall and thus may have a relatively high average A2 and a relatively large standard deviation. The controller may raise the upper limit A2U of the normal acceleration range by positioning the normal acceleration range to be high due to the relatively high average A2 of the accumulated per-time acceleration data. The controller may raise the upper limit A2U of the normal acceleration range by determining the normal acceleration range to be wide due to the relatively large standard deviation of the accumulated per-time acceleration data.

For example, an acceleration pattern of the accumulated per-time acceleration data of a third vehicle, which is replaced by a driver with a different driving style (e.g., replaced from an economical driver to a sporty driver), may gradually change as an accumulated driving time of the third vehicle of the replaced driver increases. For example, the averages A1 and A2 and standard deviation of the accumulated per-time acceleration data of the third vehicle may gradually increase, the normal acceleration range may gradually increase or widen as normal acceleration range is updated, and the upper limits A1U and A2U of the normal acceleration range may gradually increase as the upper limits A1U and A2U are updated.

For example, the controller (120 of FIG. 1) may pre-store a normal acceleration range determination logic that calculates the averages A1 and A2 and standard deviation and may apply at least a portion of the accumulated per-time acceleration data to the normal acceleration range determination logic. For example, the normal acceleration range determination logic may be configured to calculate the standard deviation by calculating the square root of an average of the squares of a difference between acceleration values that are adjacent to each other in the per-time acceleration data (or a differential value of the per-time acceleration data). Based on the design, the square root of the average of the squares may be replaced with an average of absolute values.

For example, the normal acceleration range determination logic may be configured to determine a range value corresponding to the standard deviation (e.g., the product of the standard deviation and a predetermined constant). The normal acceleration range determination logic may determine the upper limits A1U and A2U by adding the range value to the averages A1 and A2. The normal acceleration range determination logic may determine lower limits A1L and A2L by subtracting the range value from the averages A1 and A2. Based on the design, the lower limits A1L and A2L may be omitted.

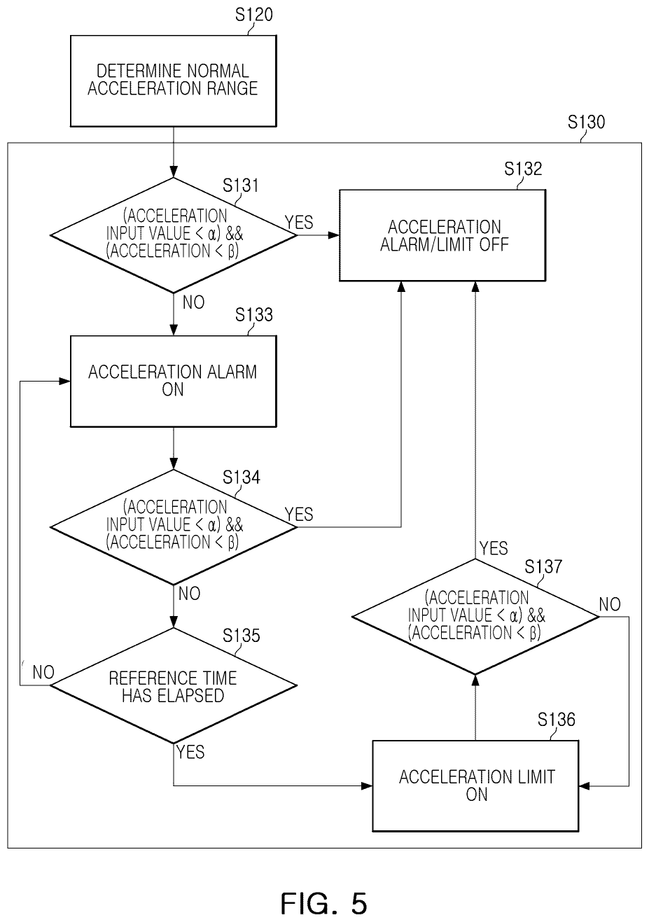

Referring to FIG. 5, in the outputting operation (S130), the controller (120 of FIG. 1) may selectively output the acceleration alarm signal (corresponding to S133) or the acceleration limit signal (corresponding to S136) based on whether the accelerator input value is greater than or equal to the accelerator input reference α (corresponding to S131 and S137).

For example, a situation in which a driver is likely to erroneously operate an accelerator input receiver (e.g., a pedal) may include an emergency situation in which the driver must work a brake pedal abruptly (e.g., a situation in which a vehicle speed is too fast or a distance to a front obstacle is too close at the time when the driver recognizes the front obstacle). In the emergency situation, the driver may try to apply a larger accelerator input to a brake receiver (e.g., a pedal) than an accelerator input that is usually applied to the accelerator input receiver (e.g., a pedal) and may mistake the accelerator input receiver (e.g., pedal) for the brake receiver (e.g., a pedal) and may apply a large accelerator input to the accelerator input receiver (e.g., a pedal).

When the accelerator input value is greater than or equal to the accelerator input reference α, the controller may determine that there is a large accelerator input and may output an acceleration alarm signal (corresponding to S133) or an acceleration limit signal (corresponding to S136). When the accelerator input value is less than the accelerator input reference α, the controller may turn off the acceleration alarm/limit (S132), thereby not outputting the acceleration alarm signal or the acceleration limit signal.

The accelerator input reference α may be fixed. For example, the accelerator input reference α may correspond to the maximum accelerator input value that the accelerator input receiver (e.g., a pedal) may receive (e.g., accelerator input value corresponding to 100% throttle opening of the engine). Meanwhile, an upper limit β of the normal acceleration range may be variable depending on the accumulated per-time acceleration data.

Referring to FIG. 5, in the outputting operation (S130 of FIG. 2), if an output condition is satisfied (corresponding to NO in S131), the controller (120 of FIG. 1) may output an acceleration alarm signal (S133). If the satisfaction of the output condition (corresponding to NO in S134) continues until a reference time has elapsed since the acceleration alarm signal was output (corresponding to YES in S135), the controller may output an acceleration limit signal (S136). Accordingly, while the accuracy/reliability of preventing an erroneous operation of an accelerator input is secured, the acceleration limit frequency (and/or unnecessary acceleration limit) may be further reduced.

If the output condition is not satisfied (YES in S131, YES in S134, and YES in S137), the controller may not output the acceleration alarm signal or the acceleration limit signal by turning off the acceleration alarm/limit (S132), and if the output condition is not satisfied (corresponding to S134) after the acceleration alarm signal was output, the controller may stop the acceleration alarm (corresponding to S132). If the output condition is not satisfied (YES in S137) after the acceleration limit signal is output (S136), the controller may stop the acceleration limit (corresponding to S132).

The output condition may include a first condition in which at least a portion of the per-time acceleration data is outside of the normal acceleration range (e.g., exceeds the upper limit β of the normal acceleration range) and a second condition in which the accelerator input value is greater than or equal to the accelerator input reference α. For example, the inverse of the first condition and the inverse of the second condition may be combined as an intersection (&&), but are not limited thereto.

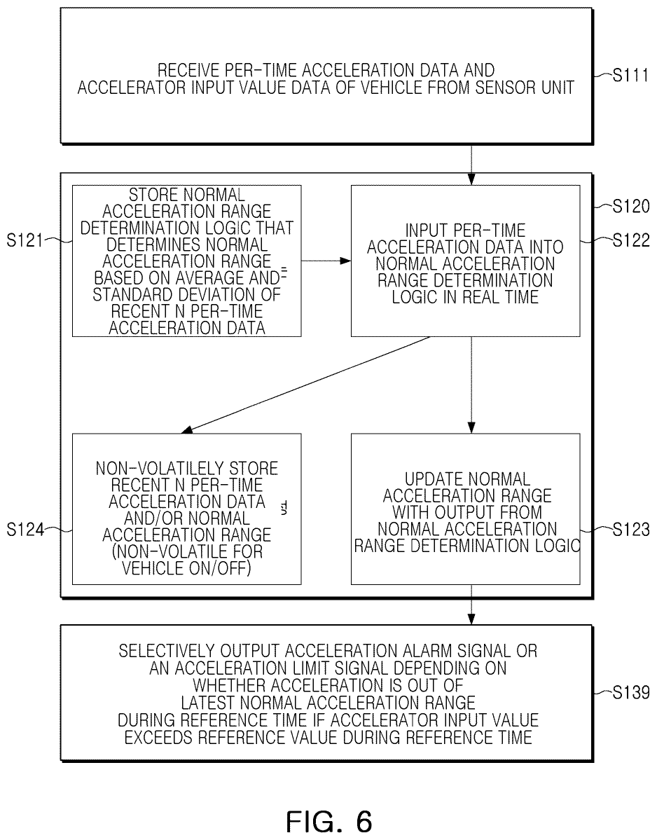

Referring to FIG. 6, in the receiving operation (S110 of FIG. 2), the controller (120 of FIG. 1) may receive (S111) the per-time acceleration data and accelerator input value data of the vehicle from the sensor unit (110 of FIG. 1). In the outputting operation (S130 of FIG. 2), when the accelerator input value exceeds the reference value during the reference time, the controller (120 of FIG. 1) may selectively output (S139) an acceleration alarm signal or an acceleration limit signal depending on whether the acceleration is out of the latest normal acceleration range during the reference time.

In the determining operation (S120), the controller (120 of FIG. 1) may store (S121) a normal acceleration range determination logic that determines the normal acceleration range based on the average and standard deviation of the recent N per-time acceleration data and may input (S122) the per-time acceleration data into the normal acceleration range determination logic in real time. The accumulated per-time acceleration data may include per-time acceleration data of recent time ranges (e.g., recent N) and per-time acceleration data of time ranges older than the recent time range.

For example, the normal acceleration range determination logic may be configured to disable or delete per-time acceleration data of older time ranges and select only per-time acceleration data of recent time ranges (e.g., recent N). The normal acceleration range determination logic may be configured to allow the controller to determine the normal acceleration range based on the per-time acceleration data of recent time ranges (e.g., recent N) and to output the normal acceleration range to update the normal acceleration range (S123).

In the determining operation (S120), the controller (120 of FIG. 1) may non-volatilely store (S124) the recent N per-time acceleration data and/or the normal acceleration range (non-volatile for vehicle ON/OFF). Due to the non-volatility, the recent time range (e.g., the recent N) may include a plurality of driving time ranges of the vehicle, and the plurality of driving time ranges may be distinguished from each other by ON/OFF of the vehicle.

The normal acceleration range determination logic may be configured so that the controller determines the normal acceleration range based on the per-time acceleration data of the plurality of driving time ranges and may be configured to output the normal acceleration range to update the normal acceleration range (S123). For example, the controller may determine the normal acceleration range based on the comprehensive average and the comprehensive standard deviation of the plurality of driving time ranges. The comprehensive average may be an average of the respective averages of the plurality of driving time ranges, and the comprehensive standard deviation may be an average of the respective standard deviations of the plurality of driving time ranges, but is not limited thereto.

Meanwhile, referring to FIG. 1, the controller 120 of the apparatus for preventing an erroneous operation of an accelerator input according to an embodiment of the present disclosure may be implemented as a computing system including at least one processor 501, a computer-readable storage medium 502, and a communication bus 503. For example, the controller 120 may be implemented as a microcontroller or an embedded system. The storage medium 502 may record one or more programs including commands for executing the method for preventing an erroneous operation of an accelerator input according to an embodiment of the present disclosure. The communication bus 503 may interconnect various other components of the computing device, including the processor 501 and the computer-readable storage medium 502.

The processor 501 may cause the controller 120 to operate according to the embodiments described above. For example, the processor 501 may execute one or more programs stored on the computer-readable storage medium 502. The one or more programs may include one or more computer-executable instructions, which, when executed by the processor 501, may be configured to cause the controller 120 to perform operations according to the embodiments.

The computer-readable storage medium 502 may be configured to store computer-executable instructions or program code, program data, and/or other suitable forms of information. A program 502a stored on the computer-readable storage medium 502 includes a set of instructions executable by the processor 501. In an embodiment, the computer-readable storage medium 502 may be memory (volatile memory, such as random access memory, nonvolatile memory, or a suitable combination thereof), one or more magnetic disk storage devices, optical disk storage devices, flash memory devices, or any other form of storage medium that may be accessed by the controller 120 and capable of storing desired information, or a suitable combination thereof.

The controller 120 may also include one or more input/output interfaces 505 providing an interface for one or more input/output devices 504 and one or more network communication interfaces 506. The input/output interfaces 505 and the network communication interfaces 506 are connected to the communication bus 503. The network may be one of a cellular network, such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), Universal Mobile Telecommunications System (UMTS), Long Term Evolution (LTE), 5G, Wi-Fi, or another cellular network, and may also be implemented as Ethernet, Media Oriented Systems Transport (MOST), Flexray, Controller region Network (CAN), Local Interconnect Network (LIN), Internet, Bluetooth®, Near Field Communication (NFC), Zigbee®, Radio Frequency (RF), etc.

The input/output device 504 may be connected to other components of the controller 120 via the input/output interface 505. The input/output devices 504 may include, for example, input devices, such as pointing devices (such as a mouse or trackpad), keyboards, touch input devices (such as a touchpad or a touchscreen), voice or sound input devices, various types of sensor devices and/or image capturing devices, and/or output devices, such as display devices, printers, speakers, and/or network cards. For example, the input/output devices 504 may be included inside the controller 120 as a component constituting the controller 120 or may be connected to the controller 120 as a separate device distinct from the controller 120.

Meanwhile, the embodiments of the present disclosure may include a program for performing the methods described in this specification on a computer and a computer-readable recording medium including the program. The computer-readable recording medium may include program instructions, local data files, local data structures, etc., alone or in combination. The medium may be those specifically designed and configured for the present disclosure or may be those commonly available in the computer software field. Examples of computer-readable recording medium include magnetic medium, such as hard disks, floppy disks, and magnetic tapes, optical recording medium, such as CD-ROMs, DVDs, and hardware devices specifically configured to store and perform program instructions, such as ROM, RAM, flash memory, etc. Examples of the program may include not only machine language code, such as that generated by a compiler, but also high-level language code that may be executed by a computer using an interpreter or the like.

The apparatus and method for preventing an erroneous operation of an accelerator input, the vehicle, and the storage medium according to an embodiment of the present disclosure may improve the accuracy/reliability of preventing an erroneous operation of an accelerator input for drivers with various driving tendencies.

For example, the apparatus and the method for preventing an erroneous operation of an accelerator input, the vehicle, and the storage medium according to an embodiment of the present disclosure may not depend on external vehicle data (e.g., camera data, radar data, lidar data) that may be temporarily abnormal due to environmental factors, and thus a time gap for causing an erroneous operation of an accelerator input may be prevented and stability in preventing an erroneous operation of an accelerator input may be secured.

While embodiments have been shown and described above, it should be apparent to those having ordinary skill in the art that modifications and variations could be made without departing from the scope of the present disclosure as defined by the appended claims.

What is claimed is:

1. An apparatus for preventing an erroneous operation of an accelerator input, the apparatus comprising:
a controller configured to:
receive per-time acceleration data of a vehicle from a sensor unit;
determine a normal acceleration range by accumulating the per-time acceleration data; and
selectively output an acceleration alarm signal or an acceleration limit signal based on whether at least a portion of the per-time acceleration data is beyond the normal acceleration range.

2. The apparatus of claim 1, wherein the accumulated per-time acceleration data includes per-time acceleration data of a recent time range and per-time acceleration data of a time range older than the recent time range, and
wherein the controller is further configured to determine the normal acceleration range based on the per-time acceleration data of the recent time range.

3. The apparatus of claim 2, wherein:
the recent time range includes a plurality of driving time ranges of the vehicle,
the plurality of driving time ranges is distinguished from each other by an ON/OFF status of the vehicle, and
the controller is further configured to determine the normal acceleration range based on per-time acceleration data of the plurality of driving time ranges.

4. The apparatus of claim 3, wherein the controller is further configured to determine the normal acceleration range based on a comprehensive average and a comprehensive standard deviation of the plurality of driving time ranges.

5. The apparatus of claim 1, wherein the controller is further configured to determine the normal acceleration range based on an average and a standard deviation of at least a portion of the accumulated per-time acceleration data.

6. The apparatus of claim 1, wherein the controller is further configured to:
receive accelerator input data from the sensor unit; and
selectively output the acceleration alarm signal or acceleration limit signal based on whether an accelerator input value is greater than or equal to an accelerator input reference.

7. The apparatus of claim 6, wherein the normal acceleration range is variable based on the accumulated per-time acceleration data, and
wherein the accelerator input reference is fixed.

8. The apparatus of claim 6, wherein the controller is further configured to:
output the acceleration alarm signal based on an output condition being satisfied; and
output the acceleration limit signal based on satisfaction of the output condition continuing until a reference time has elapsed since the acceleration alarm signal was output, and
wherein the output condition includes at least one of a first condition in which at least a portion of the per-time acceleration data is beyond the normal acceleration range or a second condition in which the accelerator input value is greater than or equal to the accelerator input reference.

9. A method for preventing an erroneous operation of an accelerator input, the method comprising:
receiving per-time acceleration data from a sensor unit;
determining a normal acceleration range by accumulating the per-time acceleration data; and
selectively outputting an acceleration alarm signal or an acceleration limit signal based on whether at least a portion of the per-time acceleration data is beyond the normal acceleration range.

10. The method of claim 9, wherein:
the accumulated per-time acceleration data includes per-time acceleration data of a recent time range and per-time acceleration data of a time range older than the recent time range, and
determining the normal acceleration range includes determining the normal acceleration range based on the per-time acceleration data of the recent time range.

11. The method of claim 10, wherein determining the normal acceleration range includes determining the normal acceleration range based on an average and standard deviation of the recent time range.

12. The method of claim 11, wherein:
receiving the per-time acceleration data includes receiving accelerator input data from the sensor unit, and
selectively outputting the acceleration alarm signal or the acceleration limit signal includes selectively outputting the acceleration alarm signal or acceleration limit signal based on whether an accelerator input value is greater than or equal to an accelerator input reference.

13. The method of claim 12, wherein:
selectively outputting the acceleration alarm signal or the acceleration limit signal includes:
outputting the acceleration alarm signal when an output condition is satisfied; and
outputting the acceleration limit signal when satisfaction of the output condition continues until a reference time has elapsed since the acceleration alarm signal was output, and
the output condition includes at least one of a first condition in which at least a portion of the per-time acceleration data is beyond the normal acceleration range or a second condition in which the accelerator input value is greater than or equal to the accelerator input reference.

14. A storage medium for recording at least one program including instructions for executing the method for preventing the erroneous operation of the accelerator input of claim 9.

15. A vehicle comprising:
a controller including a processor and a storage medium for recording at least one program configured to be executable by the processor,
wherein the at least one program includes instructions for executing the method for preventing the erroneous operation of the accelerator input of claim 9.

16. A vehicle comprising:
a sensor unit configured to receive per-time acceleration data of a vehicle; and
a controller configured to:
determine a normal acceleration range by accumulating the per-time acceleration data; and
selectively output an acceleration alarm signal or an acceleration limit signal based on whether at least a portion of the per-time acceleration data is beyond the normal acceleration range.
